(19) United States
(12) Patent Application Publication
(10) Pub. No.: US 2021/0163035 A1
(43) Pub. Date: Jun. 3, 2021

(54) VEHICLE DRIVING ASSIST APPARATUS

(71) Applicant: TOYOTA JIDOSHA KABUSHIKI KAISHA, Toyota-shi (JP)

(72) Inventors: Yuki TEZUKA, Toyota-shi (JP); Naoki KUSUMOTO, Toyota-shi (JP)

(21) Appl. No.: 16/941,712

(22) Filed: Jul. 29, 2020

(30) Foreign Application Priority Data
Nov. 29, 2019 (JP) 2019-216257

(51) Int. Cl. B60W 50/14; B60W 30/18

(52) U.S. Cl. CPC B60W 50/14; B60W 30/18054; B60W 2554/4045; B60W 2552/53; B60W 2420/42; B60W 30/18163

(57) ABSTRACT

A vehicle driving assist apparatus recognizes a moving direction of an own vehicle permitted by an arrow road marking and memorizes the recognized moving direction as a road marking direction. The apparatus recognizes a moving direction of the own vehicle permitted by an oncoming arrow traffic light ahead of the own vehicle as an arrow traffic light direction. The apparatus determines whether the oncoming arrow traffic light permits the own vehicle to move in the memorized arrow traffic light direction, based on the memorized road marking direction and the recognized arrow traffic light direction. The apparatus prompts the driver of the own vehicle to start to move the own vehicle when the own vehicle is still stopped after determining that the oncoming arrow traffic light permits the own vehicle to move in the memorized arrow traffic light direction.

### BACKGROUND

### Field

The invention relates to a vehicle driving assist apparatus which prompts a driver of an own vehicle to start to move the own vehicle.

### Description of the related art

There is known a vehicle driving assist apparatus which prompt a driver of an own vehicle to start to move the own vehicle when the vehicle is still stopped even after a traffic light permits the own to start to move. For example, JP 2014-10775 A discloses a vehicle informing apparatus which prompts the driver of the own vehicle to start to move the own vehicle with informing voice announcement when the own vehicle is still stopped even after the traffic light changes from a state of lighting a red lamp to a state of lighting a green lamp.

The disclosed vehicle informing apparatus does not address arrow traffic lights. For example, even when the disclosed vehicle informing apparatus may detect a moving direction of the own vehicle permitted by the arrow traffic light, the disclosed vehicle informing apparatus may not realize in which direction the driver will move the own vehicle. Thus, the disclosed vehicle informing apparatus may not properly prompt the driver to start to move the own vehicle in response to lighting states of the arrow traffic light at an intersection.

### SUMMARY

The invention has been made for solving the above-mentioned problems. An object of the invention is to provide a vehicle driving assist apparatus which can properly prompt the driver of the own vehicle to start to move the own vehicle in response to the lighting states of the arrow traffic light at the intersection.

A vehicle driving assist apparatus according to the invention comprises an electronic control unit configured to prompt a driver of an own vehicle to start to move the own vehicle when the own vehicle is still stopped after an oncoming traffic light ahead of the own vehicle permits the own vehicle to start to move.

The vehicle driving assist apparatus according to the invention further comprises at least one sensor which detects an arrow road marking on a road in a lane in which the own vehicle is moving.

The electronic control unit is configured to (i) acquire road marking information on the arrow road marking detected by the at least one sensor, (ii) recognize a moving direction of the own vehicle permitted by the detected arrow road marking, based on the acquired road marking information, and (iii) memorize the recognized moving direction as a road marking direction. In addition, the electronic control unit is configured to (i) acquire a lighting state of an oncoming arrow traffic light ahead of the own vehicle and (ii) recognize a moving direction of the own vehicle permitted by the oncoming arrow traffic light as an arrow traffic light direction, based on the acquired lighting state.

Moreover, the electronic control unit is configured to determine whether the oncoming arrow traffic light permits the own vehicle to move in the memorized arrow traffic light direction, based on (i) the memorized road marking direction and (ii) the recognized arrow traffic light direction. In addition, the electronic control unit is configured to prompt the driver of the own vehicle to start to move the own vehicle when the own vehicle is still stopped after the electronic control unit determines that the oncoming arrow traffic light permits the own vehicle to move in the memorized arrow traffic light direction.

The vehicle driving assist apparatus according to the invention prompts the driver to move the own vehicle when the own vehicle is still stopped after the oncoming traffic light ahead of the own vehicle permits the own vehicle to start to move. Prompting the driver to move the own vehicle is to inform the driver that (i) the lighting state of the oncoming traffic light changes, and (ii) the driver is permitted to move the own vehicle when the driver is waiting for the oncoming traffic light to change.

The at least one sensor detects the arrow road marking on the road in the lane in which the own vehicle is moving. The arrow road marking indicates a permitted moving direction/directions. The electronic control unit memorizes the moving direction permitted by the arrow road marking for the own vehicle to move as the road marking direction when the at least one sensor detects the arrow road marking.

The electronic control unit (i) acquires the lighting state of the oncoming arrow traffic light ahead of the own vehicle and (ii) recognize the arrow traffic light direction permitted for the own vehicle to move, based on the acquired lighting state. The lighting state of the oncoming arrow traffic light corresponds to information on a direction indicated by the lighting arrow traffic light. For example, the electronic control unit may acquire such information by analyzing images taken by a camera. Alternatively the electronic control unit may acquire such information sent from equipment at the side of the road.

The electronic control unit prompts the driver to start to move the stopped own vehicle when the electronic control unit determines that the oncoming arrow traffic light permits the driver to move the own vehicle in the memorized road marking direction, based on (i) the memorized road marking direction and (ii) the recognized arrow traffic light direction. For example, when (i) the road marking direction is a right turn direction, and (ii) the arrow traffic light direction is the right turn direction, the oncoming arrow traffic light permits the own vehicle to move in the road marking direction. In this case, the driver is prompted to start to move the own vehicle when the own vehicle is stopped.

Thereby, the driver can be prompted to start to move the own vehicle at the intersection with the arrow traffic light.

According to an aspect of the invention, the electronic control unit may be configured to delete the memorized road marking direction when the electronic control unit determines that the own vehicle changes lanes.

For example, when the own vehicle changes the lanes, the arrow road marking on the road in the lane in which the own vehicle is currently moving, may be different from the arrow road marking on the road in the lane in which the own vehicle was previously moving.

According to this aspect of the invention, the electronic control unit determines whether the own vehicle changes the lanes. When the electronic control unit determines that the own vehicle changes the lanes, the electronic control unit deletes the memorized road marking direction. Therefore, the electronic control unit does not perform prompting the driver to start to move the own vehicle unless the electronic control unit memorizes new road marking direction. Thereby, wrongly prompting the driver to start to move the own vehicle due to the own vehicle changing the lanes, can be prevented.

The electronic control unit may be configured to determine that the own vehicle changes the lanes when the electronic control unit detects that the own vehicle actually changes the lanes. Alternatively, the electronic control unit may be configured to determine that the own vehicle changes the lanes when the electronic control unit detects a driver's operation to cause the own vehicle to change the lanes.

According to another aspect of the invention, the electronic control unit may be configured to delete the memorized road marking direction when the electronic control unit determines that (i) a blinker of a preceding vehicle ahead of the own vehicle blinks, and (ii) a moving direction of the preceding vehicle indicated by the blinking blinker is different from the memorized road marking direction.

The road marking direction which the electronic control unit has memorized, is not always correct. For example, when paint of the arrow road marking is damaged, the electronic control unit may erroneously recognize the road marking direction. Thus, it is desired to determine whether the road marking direction which the electronic control unit has memorized, is correct. For example, when (i) right blinkers of the preceding vehicle blink, and (ii) the road marking direction which the electronic control unit has memorized, is a left turn direction, the memorized road marking direction may be wrong.

According to this aspect of the invention, the electronic control unit detects a blinking state of the blinker of the preceding vehicle ahead of the own vehicle. The electronic control unit deletes the memorized road marking direction when the electronic control unit determines that the moving direction of the preceding vehicle indicated by the blinking blinker is different from the memorized road marking direction For example, when (i) the memorized road marking direction includes plural directions, and (ii) the moving direction indicated by the blinking blinker is not covered by the memorized road marking direction, the moving direction indicated by the blinking blinker is determined to be different from the memorized road marking direction. In particular, when (i) the memorized road marking direction includes the right turn direction and the straight direction, and (ii) the blinking blinker of the preceding vehicle indicates the left turn direction, the moving direction indicated by the blinking blinker is determined to be different from the memorized road marking direction.

Thereby, the electronic control unit does not perform prompting the driver to start to move the own vehicle unless the electronic control unit memorizes new road marking direction. In other words, the electronic control unit can recognize that the memorized road marking direction is wrong, based on the blinking state of the blinker of the preceding vehicle when the memorized road marking direction is wrong. Thereby, wrongly prompting the driver to start to move the own vehicle can be prevented.

According to further another aspect of the invention, the electronic control unit may be configured to delete the memorized road marking direction when the electronic control unit determines that a moving direction of a preceding vehicle ahead of the own vehicle is different from the memorized road marking direction.

The memorized road marking direction is not always correct. For example, when (i) the preceding vehicle turns right, and (ii) the memorized road marking direction is the left turn direction, the memorized road marking direction may be wrong.

According to this aspect of the invention, the electronic control unit detects the moving direction of the preceding vehicle ahead of the own vehicle. The electronic control unit deletes the memorized road marking direction when the electronic control unit determines that the detected moving direction of the preceding vehicle is different from the memorized road marking direction. For example, when (i) the memorized road marking direction includes plural directions, and (ii) the moving direction of the preceding vehicle is not covered by the memorized road marking direction, the moving direction of the preceding vehicle is determined to be different from the memorized road marking direction. In particular, when (i) the memorized road marking direction includes the right turn direction and the straight direction, and (ii) the moving direction of the preceding vehicle is the left turn direction, the moving direction of the preceding vehicle is determined to be different from the memorized road marking direction.

Thereby, the electronic control unit does not perform prompting the driver to start to move the own vehicle unless the electronic control unit memorizes new road marking direction. In other words, the electronic control unit can recognize that the memorized road marking direction is wrong, based on the moving direction of the preceding vehicle when the memorized road marking direction is wrong. Thereby, wrongly prompting the driver to start to move the own vehicle can be prevented.

According to further another aspect of the invention, the electronic control unit may be configured to delete the memorized road marking direction when the electronic control unit (10) determines that a moving distance of the own vehicle since the arrow road marking is lastly detected, reaches a predetermined distance.

The arrow road markings are provided with a constant distance interval. Therefore, when (i) one arrow road marking is detected, and (ii) another arrow road marking has not been detected when the own vehicle moves a constant distance after the one arrow road marking is detected, the memorized road marking direction may be an outdated road marking direction which should not be used.

According to this aspect of the invention, the electronic control unit detects the moving distance which the own vehicle has moved since the electronic control unit lastly detects the arrow road marking. The electronic control unit deletes the memorized road marking direction when the electronic control unit determines that the detected moving distance reaches the predetermined distance. The predetermined distance may be set, based on the distance interval with which the arrow road markings indicating the permitted moving directions are provided.

Thereby, the electronic control unit does not perform prompting the driver to start to move the own vehicle unless the electronic control unit memorizes new road marking direction. Thereby, wrongly prompting the driver to start to move the own vehicle can be prevented.

According to further another aspect of the invention, the electronic control unit may be configured to (i) acquire the lighting state of the oncoming arrow traffic light and (ii) recognize the moving direction of the own vehicle permitted by the oncoming arrow traffic light as the arrow traffic light direction, based on the acquired lighting state when the own vehicle is stopped.

According to further another aspect of the invention, the electronic control unit may be configured to prompt the driver of the own vehicle to start to move the own vehicle when the own vehicle is still stopped when a predetermined amount of time elapses since the electronic control unit determines that the oncoming arrow traffic light permits the own vehicle to move in the memorized arrow traffic light direction.

According to further another aspect of the invention, the electronic control unit may be configured to delete the memorized road marking direction when the electronic control unit determines that (i) a blinker of the own vehicle blinks, and (ii) a moving direction indicated by the blinking blinker of the own vehicle is different from the memorized road marking direction.

According to further another aspect of the invention, the at least one sensor may include a camera which takes images of a view ahead of the own vehicle. In this case, the electronic control unit may be configured to acquire the road marking information from information on the images taken by the camera.

According to further another aspect of the invention, the electronic control unit may be configured to acquire the lighting state of the oncoming arrow traffic light from the information on the images taken by the camera.

Elements of the invention are not limited to elements of embodiments and modified examples of the invention described along with the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle driving assist apparatus according to an embodiment of the invention.

FIG. 2 is a plane view which shows an intersection and roads around the intersection.

FIG. 3 is a plane view which shows road markings.

FIG. 4 is a view which shows a flowchart of a traffic light change informing control routine.

FIG. 5 is a view which shows a flowchart of a memorized information keeping determination routine.

### DESCRIPTION OF THE EMBODIMENTS

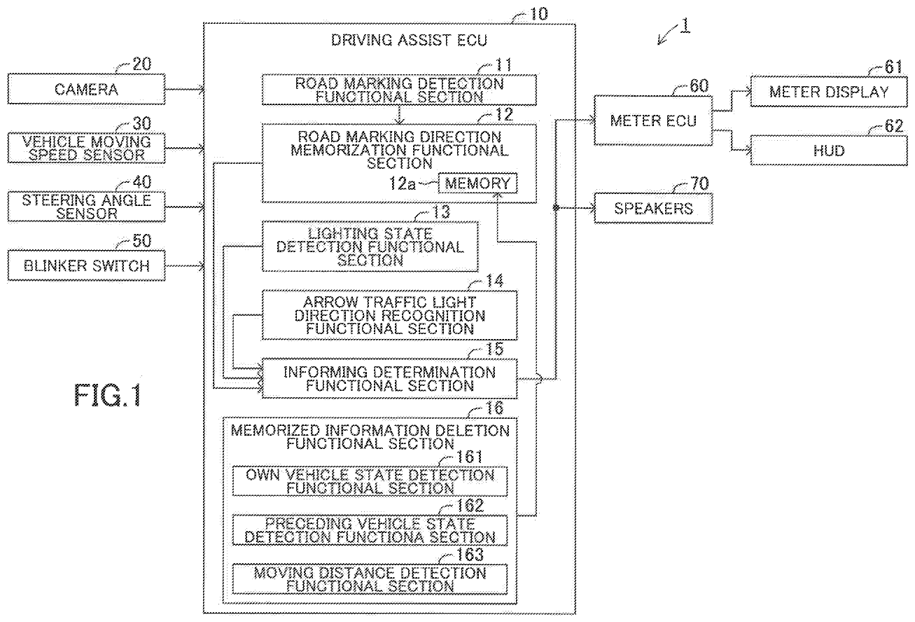

Below, a vehicle driving assist apparatus according to an embodiment of the invention will be described with reference to the drawings. FIG. 1 is a view showing the vehicle driving assist apparatus according to the embodiment of the invention.

The vehicle driving assist apparatus 1 includes a driving assist ECU 10. The driving assist ECU 10 includes a micro-computer as a main component. The ECU stands for Electronic Control Unit. In this embodiment, the micro-computer includes a CPU, a ROM, and a memory device such as a RAM. The CPU realizes various functions by executing instructions and programs memorized in the ROM. A vehicle installed with the vehicle driving assist apparatus 1 will be referred to as “the own vehicle” in order to distinguish the vehicle installed with the vehicle driving assist apparatus 1 from other vehicles.

The driving assist ECU 10 informs a driver of the own vehicle to assist a driver's driving operation when the driver overlooks changing of a traffic light while the driver is waiting for a lighting state of the traffic light to change. That is, the driving assist ECU 10 executes a traffic light change informing control to prompt the driver to start to move the own vehicle when the own vehicle is still stopped after the traffic light permits the own vehicle to start to move. A traffic light change means changing of the lighting state of the traffic light. The traffic light includes a standard traffic light and an arrow traffic light, and the lighting state of the traffic light includes a red lighting state, a green lighting state, and a yellow or an amber lighting state of the standard traffic light as well as arrow lighting states of the arrow traffic light.

The driving assist ECU 10 is electrically connected to a camera 20, a vehicle moving speed sensor 30, a steering angle sensor 40, a blinker switch 50, a meter ECU 60, and speakers 70.

The camera 20 is provided, for example, on an upper portion of a front windshield in an interior of the own vehicle. The camera 20 takes images of a view ahead of the own vehicle. The camera 20 provides data on the taken images to the driving assist ECU 10 with a predetermined cycle. In this embodiment, the camera 20 is a monocular camera. The camera 20 may be a stereo camera. Moreover, in this embodiment, the driving assist ECU 10 and the camera 20 are housed in a common casing as one unit. The driving assist ECU 10 and the camera 20 may be separately provided.

The vehicle moving speed sensor 30 detects a moving speed of the own vehicle. The vehicle moving speed sensor 30 provides detection signals representing the detected moving speeds to the driving assist ECU 10 with a predetermined cycle. Hereinafter, the moving speed of the own vehicle will be referred to as “the vehicle moving speed.”

The steering angle sensor 40 detects a steering angle corresponding to a rotation angle of a steering wheel of the own vehicle. The steering angle sensor 40 provides detection signals representing the detected steering angles to the driving assist ECU 10 with the predetermined cycle.

The blinker switch 50 detects an activation state or a blinking state of a left blinker and an activation state or a blinking state of a right blinker. The blinker switch 50 provides detection signals representing the detected blinking states to the driving assist ECU 10 with the predetermined cycle.

The meter ECU 60 is electrically connected to a meter display 61 and a head-up display 62. Hereinafter, the head-up display 62 will be referred to as “the HUD62.” The meter display 61 is a multi-information display which displays meters such as a vehicle moving speed meter and various information to be informed to the driver. The HUD 62 is a display device which displays various information on a display area corresponding to a part of the front windshield of the own vehicle.

The meter ECU 60 displays traffic light change messages on the meter display 61 and the HUD 62 in response to traffic light change informing request commands sent from the driving assist ECU 10. The traffic light change messages are realized by character display such as “TRAFFIC LIGHT CHANGE”. In addition, the meter ECU 60 clears the traffic light change messages from the meter display 61 and the HUD 62 in response to traffic light change informing termination commands sent from the driving assist ECU 10.

The speakers 70 generate buzzer sounds for a predetermined amount of time in response to buzzer sound drive signals sent from the driving assist ECU 10.

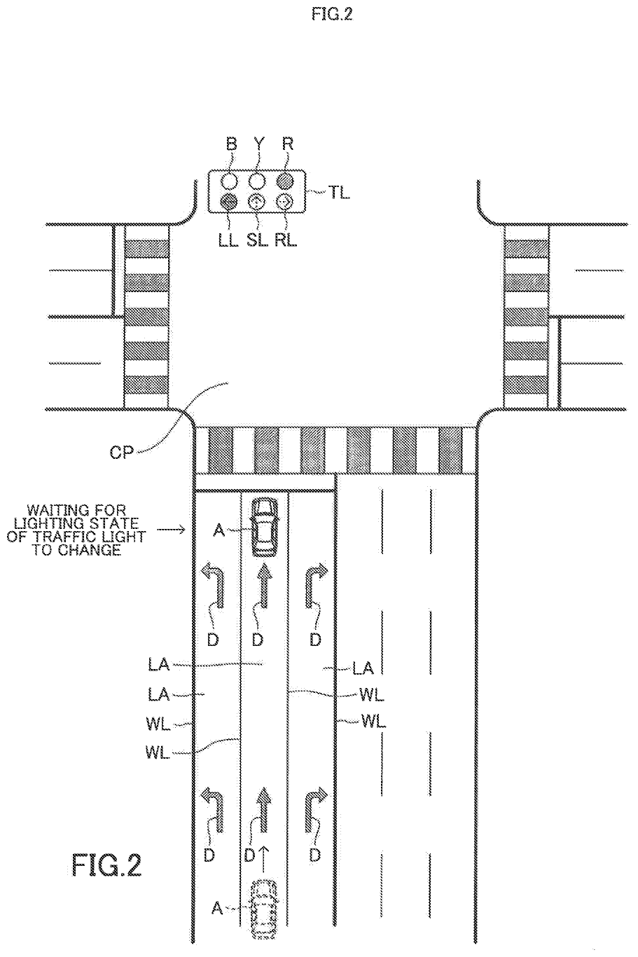

The driving assist ECU 10 includes an image processing device as a main section. The image processing device performs an image processing to process the data on the images provided from the camera 20. The driving assist ECU 10 recognizes the lighting state of the traffic light by the image processing. As shown in FIG. 2, the traffic light is a traffic light TL at an intersection CP into which the own vehicle is moving. The traffic light TL is in front of the own vehicle A. Therefore, the driver is required to follow the traffic light TL. FIG. 2 shows a situation in which the driver is waiting for the lighting states of the traffic light TL to change. Therefore, the own vehicle A is stopped before the intersection CP.

The driving assist ECU 10 performs the image processing to recognize which of the green lighting state B, the yellow or amber lighting state Y, and the red lighting state R, the present lighting state of the traffic light TL is. When the traffic light TL includes a left turn arrow traffic lamp LL, a straight arrow traffic lamp SL, and a right turn arrow traffic lamp LR, the driving assist ECU 10 recognizes which of the arrow traffic lamps is lighted.

Hereinafter, information on the lighting state of the traffic light TL recognized by the driving assist ECU 10, will be referred to as “the traffic light information.” Furthermore, information on a direction or directions indicated by the lighting arrow lamps of the arrow traffic light, will be “the arrow traffic light information.” In this embodiment, the arrow traffic light information is a part of the traffic light information.

The driving assist ECU 10 can recognize the direction or the directions permitted to move the own vehicle, based on the arrow traffic light information. Hereinafter, the direction or the directions permitted to move the own vehicle, based on the arrow traffic light information, will be referred to as “the arrow traffic light direction.”

The driving assist ECU 10 recognizes (i) white lane markings WL or lane separation markings WL on a road and (ii) arrow road markings D on the road in lanes LA. The arrow road markings D are direction indicating road markings which indicate permitted moving directions by arrows provided in the lanes LA. The arrow road markings are provided with constant distance intervals before the intersection CP. The driving assist ECU 10 recognizes the permitted moving directions specified by the arrow road markings. Hereinafter, the permitted moving direction specified by the arrow road marking D, will be referred to as “the road marking direction.”

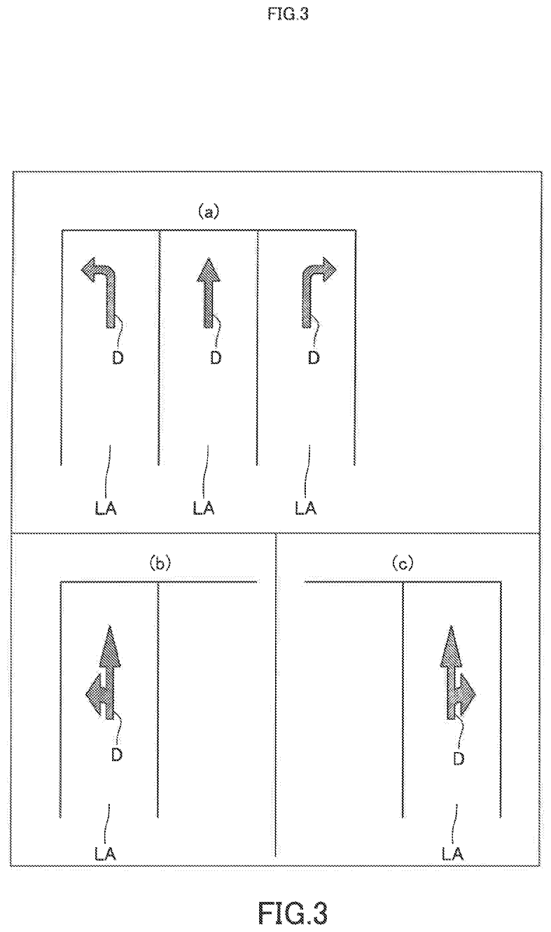

It should be noted that the arrow road markings D include (i) arrow road markings indicating only one direction as shown in FIG. 3(a), (ii) arrow road markings indicating a left turn direction and a straight direction as shown in FIG. 3(b), and (iii) arrow road markings indicating a right turn direction and the straight direction as shown in FIG. 3(c).

The driving assist ECU 10 recognizes a relationship in position between the own vehicle A and the white lane markings WL and a relationship in position between the own vehicle A and the arrow road markings D. Therefore, the driving assist ECU 10 specifies the lane LA in which the own vehicle A is now moving and distinguishes the arrow road marking D in the lane LA in which the own vehicle A is now moving from the arrow road markings D in the lanes LA other than the lane LA in which the own vehicle A is now moving. Hereinafter, the lane LA in which the own vehicle A is now moving, will be referred to as “the own vehicle moving lane LA.” When the driving assist ECU 10 recognizes the arrow road marking D in the own vehicle moving lane LA, the driving assist ECU 10 memorizes information on the arrow road marking direction indicated by the recognized arrow road marking D. Hereinafter, information on the white lane markings WL which the driving assist ECU 10 recognizes, will be referred to as “the white lane marking information.” Furthermore, information on the arrow road markings D in the own vehicle moving lane LA which the driving assist ECU 10 recognizes, will be referred to as “the road marking information.”

The driving assist ECU 10 performs the image processing to recognize another vehicle ahead of the own vehicle. The driving assist ECU 10 recognizes a relationship between the own vehicle and the other vehicle. This relationship includes a direction of the other vehicle relative to the own vehicle, a distance between the own vehicle and the other vehicle, and a moving speed of the other vehicle relative to the own vehicle.

The driving assist ECU 10 recognizes a preceding vehicle moving in the own vehicle lane LA, based on the relationship in position between the own vehicle lane LA and the other vehicle. The driving assist ECU 10 also recognizes (i) a moving route of the preceding vehicle and (ii) blinking states of blinkers of the preceding vehicle. Hereinafter, information on the preceding vehicle which the driving assist ECU 10 recognizes, will be referred to as “the preceding vehicle information.” The recognition of such objects are realized by a machine-learning such as a pattern matching technique.

In this embodiment, the driving assist ECU 10 recognizes the preceding vehicle, based on the data on the images taken by the camera 20. In this regard, the driving assist ECU 10 may be configured to detect the preceding vehicle by other front sensors such as radar sensors.

<Traffic Light Change Informing Control>

Next, the traffic light change informing control will be described. As shown in FIG. 1, the driving assist ECU 10 includes a road marking detection functional section 11, a road marking direction memorization functional section 12, a traffic light state detection functional section 13, an arrow traffic light direction recognition functional section 14, an informing determination functional section 15, and a memorized information deletion functional section 16. The memorized information deletion functional section 16 includes an own vehicle state detection functional section 161, a preceding vehicle state detection functional section 162, and a moving distance detection functional section 163.

The road marking detection functional section 11 detects the arrow road markings provided in the own vehicle lane LA, based on (i) the white lane marking information and (ii) the road marking information acquired by the image processing. The arrow road marking indicates a permitted moving direction or permitted moving directions permitted for the own vehicle in the own vehicle lane LA to move at the intersection. Therefore, the road marking detection functional section 11 can presume a route or a moving direction of the own vehicle at the intersection. The moving direction of the own vehicle includes any one or more of (i) a left turn direction, (ii) a straight direction, (iii) a right turn direction, (iv) the left turn direction or the straight direction, and (v) the right turn direction or the straight direction. The road marking detection functional section 11 recognizes the road marking direction indicated by the arrow road marking at the point of time when the road marking detection functional section 11 detects the arrow road marking.

The road marking direction memorization functional section 12 includes a memory 12a. The road marking detection functional section 11 memorizes or overwrites the road marking information on the road marking direction in the memory 12a each time the arrow road marking is detected by the road marking detection functional section 11. Thereby, the latest road marking information is memorized in the road marking direction memorization functional section 12 (in particular, the memory 12a).

The traffic light state detection functional section 13 detects the present lighting state of the standard traffic light at the intersection into which the own vehicle is moving, recognizing which of the green, yellow or amber, and red lighting states, the present lighting state of the standard traffic light is, based on the standard traffic light information acquired by the image processing.

The arrow traffic light direction recognition functional section 14 recognizes one or more directions indicated by the arrow traffic lamp(s) lighting in green, i.e., the arrow traffic light direction, based on the arrow traffic light information acquired by the image processing. The arrow traffic light lights any one of a right turn arrow lamp, a left turn arrow lamp, and a straight arrow lamp or a combination of two or more of the right turn arrow lamp, the left turn arrow lamp, and the straight arrow lamp. For example, the arrow traffic light may light (i) the right turn arrow lamp RL, (ii) the straight arrow lamp SL, (iii) the left turn arrow lamp LL, (iv) both the right turn and straight arrow lamps RL and SL, (v) both the left turn and straight arrow lamps LL and SL, or (vi) all the right turn, straight, and left turn arrow lamps RL, RL, and LL. Thus, the arrow traffic light direction recognition functional section 14 is configured to recognize the arrow traffic light direction with recognizing the combination of the arrow lamps.

The informing determination functional section 15 determines whether the lighting state of the traffic light (including the standard traffic light and the arrow traffic light) changes to a state of permitting the own vehicle to move in the road marking direction, based on (i) the road marking direction memorized in the road marking direction memorization functional section 12 and (ii) the lighting state of the traffic light (including the standard traffic light and the arrow traffic light) when the own vehicle is stopped before the intersection, i.e., when the driver is waiting for the lighting state of the traffic light to change. When the informing determination functional section 15 determines that the own vehicle does not start to move when a predetermined amount of time elapses since the informing determination functional section 15 determines that the lighting state of the traffic light changes to the state of permitting the own vehicle to move in the road marking direction, the informing determination functional section 15 sends a traffic light change informing request command to the meter ECU 60 and causes the speakers 70 to generate the buzzer sounds.

For example, the informing determination functional section 15 determines that the lighting state of the traffic light changes to the state of permitting the own vehicle to move in the road marking direction, independently of the road marking direction when the lighting state of the standard traffic light changes from the red lighting state to the green lighting state.

When (i) the lighting state of the arrow traffic light changes, (ii) the arrow traffic light direction includes one direction (i.e., any one of the left turn direction, the straight direction, and the right turn direction), (iii) the road marking direction includes one direction (i.e., any one of the left turn direction, the straight direction, and the right turn direction), and (vi) the arrow traffic light direction corresponds to the road marking direction, the lighting state of the traffic light is determined to permit the own vehicle to move in the road marking direction. When (i) the arrow traffic light direction or the road marking direction includes plural directions, and (ii) the arrow traffic light direction covers the directions included in the road marking direction, the lighting state of the traffic light is determined to permit the own vehicle to move in the road marking direction. For example, when the road marking direction includes both the left turn direction and the straight direction, the arrow traffic light direction needs to include both the left turn direction and the straight direction.

When (i) the arrow traffic lamp(s) is/are lighted, and (ii) the road marking direction(s) is/are not memorized in the road marking direction memorization functional section 12 (in particular, the memory 12a), the informing determination functional section 15 does not determine that the lighting state of the arrow traffic light changes to the state of permitting the own vehicle to move in the road marking direction.

The road marking direction memorization functional section 12 memorizes or overwrites the road marking information on the road marking direction in the memory 12a each time the arrow road marking is detected by the road marking detection functional section 11. In this regard, the memorized road marking direction is not always correct. For example, after the own vehicle changes the lanes, the arrow road marking on the road in the current own vehicle lane LA may be different from the arrow road marking on the road in the previous own vehicle lane LA.

Moreover, when the arrow road marking is detected, the road marking direction indicated by the detected arrow road marking may not be correctly recognized. Moreover, the arrow road markings are provided with a constant distance interval. Therefore, when one arrow road marking is detected, and another arrow road marking is not detected before the own vehicle moves for a constant distance after the one arrow road marking is detected, the road marking direction memorized in the memory 12a may be an outdated road marking direction which should not be used in the traffic light change informing control.

Accordingly, the memorized information deletion functional section 16 has a function to delete the road marking information memorized in the memory 12a. The memorized information deletion functional section 16 includes the own vehicle state detection functional section 161, the preceding vehicle state detection functional section 162, and the moving distance detection function section 163. The detection functional sections 161 to 163 determine whether a predetermined memorized information deletion condition is satisfied. When the detection functional sections 161 to 163 determine that the predetermined memorized information deletion condition is satisfied, the detection functional sections 161 to 163 delete the road marking information memorized in the memory 12a.

In particular, the own vehicle state detection functional section 161 determines whether an own vehicle determination condition is satisfied. The own vehicle state detection functional section 161 is configured to memorize following own vehicle determination conditions 1-1 and 1-2. The own vehicle state detection functional section 161 determines whether at least one of the own vehicle determination conditions 1-1 and 1-2 is satisfied.

1-1: Any one of left and right front wheels of the own vehicle crosses the white lane marking defining the own vehicle lane LA.

1-2: The steering angle θ becomes larger than a lane change determination steering angle θref (θ>θref).

The own vehicle determination conditions 1-1 and 1-2 are conditions for determining whether the own vehicle changes the lanes.

When at least one of the own vehicle determination conditions 1-1 and 1-2 becomes satisfied, the own vehicle state detection functional section 161 determines that the predetermined memorized information deletion condition becomes satisfied. When the predetermined memorized information deletion condition is determined to become satisfied by the own vehicle state detection functional section 161, the memorized information deletion functional section 16 deletes the road marking information memorized in the memory 12a of the road marking direction memorization functional section 12.

The preceding vehicle state detection functional section 162 determines whether a preceding vehicle determination condition is satisfied. The preceding vehicle state detection functional section 162 is configured to memorize following preceding vehicle determination conditions 2-1 and 2-2. The preceding vehicle state detection functional section 162 determines whether at least one of the preceding vehicle determination conditions 2-1 and 2-2 is satisfied.

2-1: A direction indicated by the blinking blinker of the preceding vehicle is different from the road marking direction memorized in the memory 12a.

2-2: A direction of a moving route of the preceding vehicle is different from the road marking directions memorized in the memory 12a.

The preceding vehicle determination conditions 2-1 and 2-2 are conditions for determining whether a moving direction of the preceding vehicle is different from the road marking direction. The road marking direction may include plural directions. Thus, when the moving direction of the preceding vehicle (in particular, the direction indicated by the blinking blinker of the preceding vehicle and the direction of the moving route of the preceding vehicle) is not covered by the road marking direction, the preceding vehicle determination conditions 2-1 and 2-2 are satisfied.

When the preceding vehicle state detection functional section 162 determines that at least one of the preceding vehicle determination conditions 2-1 and 2-2 becomes satisfied, the preceding vehicle state detection functional section 162 determines that the predetermined memorized information deletion condition becomes satisfied. When the predetermined memorized information deletion condition is determined to become satisfied by the preceding vehicle state detection functional section 162, the memorized information deletion functional section 16 deletes the road marking information memorized in the memory 12a of the road marking direction memorization functional section 12.

The moving distance detection function section 163 determines whether a moving distance determination condition is satisfied. The moving distance detection function section 163 is configured to memorize a following moving distance determination condition 3. The moving distance detection function section 163 determines whether the moving distance determination condition 3 is satisfied.

3: A moving distance d which the own vehicle has moved after the arrow road marking is lastly detected, becomes equal to or longer than a predetermined distance dref (d≥dref).

When the moving distance detection function section 163 determines that the moving distance determination condition 3 becomes satisfied, the moving distance detection function section 163 determines that the predetermined memorized information deletion condition becomes satisfied. The moving distance of the own vehicle can be measured by the vehicle moving speed sensor 30. In this regard, for example, an accurate measurement result can be acquired by measuring the moving distance by counting the number of pulse signals output from vehicle wheel rotation speed sensor(s). When the predetermined memorized information deletion condition is determined to become satisfied by the moving distance detection function section 163, the memorized information deletion functional section 16 deletes the road marking information memorized in the memory 12a of the road marking direction memorization functional section 12.

The predetermined distance dref is a distance set, based on a road marking distance interval with which the arrow road markings indicating the permitted moving directions are provided. Therefore, the predetermined distance dref is set to a value larger than the road marking distance interval.

<Traffic Light Change Informing Control Routine>

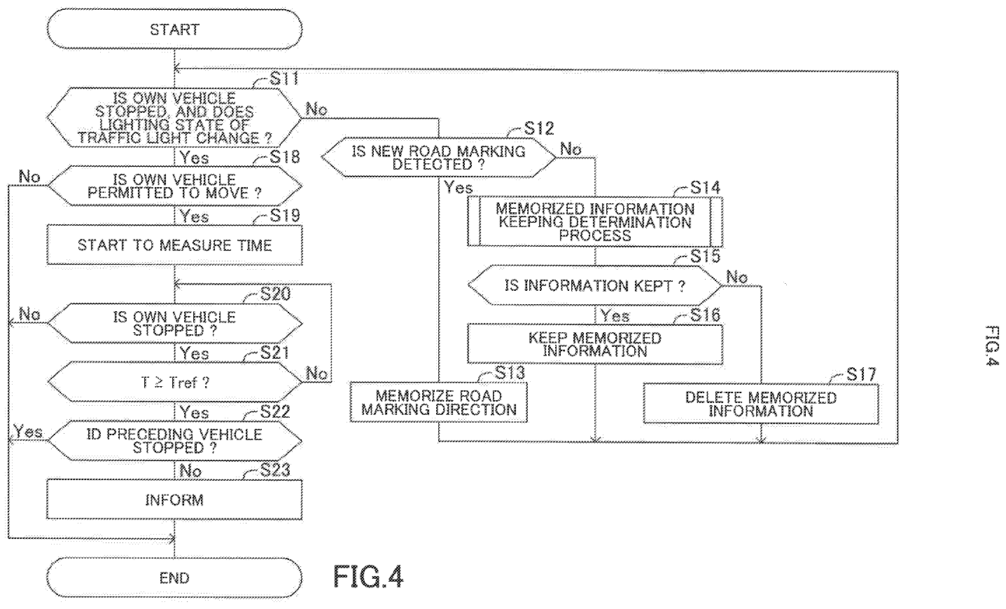

Next, processes which the functional sections 11 to 16 execute together, will be described. FIG. 4 shows a traffic light change informing control routine executed by the driving assist ECU 10.

When the driving assist ECU 10 starts to execute the traffic light change informing control routine starts, the driving assist ECU 10 proceeds with the process to a step S11 to acquire moving speed information and the traffic light information. The driving assist ECU 10 determines whether (i) the own vehicle is stopped, and (ii) the lighting state of the traffic light changes. In other words, the driving assist ECU 10 determines whether (i) the own vehicle is waiting for the lighting state of the traffic light to change, and (ii) the lighting state of the traffic light changes.

When the driving assist ECU 10 determines that the driver of the own vehicle is not waiting for the traffic light to change, or the lighting state of the traffic light does not change (S11: No), the driving assist ECU 10 proceeds with the process to a step S12 to determine whether the driving assist ECU 10 detects new arrow road marking. When the driving assist ECU 10 determines that the driving assist ECU 10 detects the new arrow road marking, the driving assist ECU 10 proceeds with the process to a step S13 to memorize or overwrite the road marking direction indicated by the detected new arrow road marking in the memory 12a. Then, the driving assist ECU 10 returns the process to the step S11.

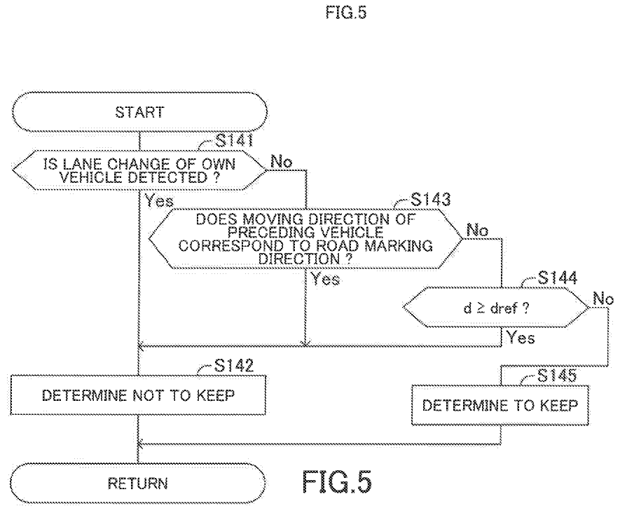

When the driving assist ECU 10 determines that the driving assist ECU 10 does not detect new arrow road marking at the step S12, the driving assist ECU 10 proceeds with the process to a step S14 to execute a memorized information keeping determination process. The memorized information keeping determination process is a process to determine whether to keep or delete the memorized road marking information on the road marking direction. The memorized information keeping determination process is executed by the own vehicle state detection functional section 161, the preceding vehicle state detection functional section 162, and the moving distance detection function section 163. The memorized information keeping determination process is realized by a memorized information keeping determination routine shown in FIG. 5. The memorized information keeping determination process (S14) will be described after the entire traffic light change informing control has been described.

When the driving assist ECU 10 determines to keep the memorized road marking information by the memorized information keeping determination process (S15: Yes), the driving assist ECU 10 proceeds with the process to a step S16 to keep the road marking information memorized in the memory 12a.

On the other hand, when the driving assist ECU 10 determines not to keep the memorized road marking information by the memorized information keeping determination process (S15: No), the driving assist ECU 10 proceeds with the process to a step S17 to delete the road marking information memorized in the memory 12a.

When the road marking information is not memorized in the memory 12a, the present state of the memory 12a is kept, independently of determining to keep and not to keep the memorized road marking information.

The driving assist ECU 10 repeatedly executes the above-described processes. Thereby, the road marking information on the road marking direction is memorized in the memory 12a (S13) each time the arrow road marking on the road in the own vehicle lane LA is newly detected or recognized (S12: Yes). Moreover, when new arrow road marking is not detected, the road marking information memorized in the memory 12a is deleted (S17) each time the road marking information memorized in the memory 12a is determined not to be kept by the memorized information keeping determination process (S15 No).

The driving assist ECU 10 repeatedly executes such processes. When the driving assist ECU 10 determines that the lighting state of the traffic light changes (S11: Yes), the driving assist ECU 10 proceeds with the process to a step S18 to determine whether the traffic light permits the own vehicle to move. When the traffic light is in the green lighting state, the driving assist ECU 10 determines that the own vehicle is permitted to move, independently of the road marking direction memorized in the memory 12a (S18: Yes). When the arrow traffic light is lighted, the driving assist ECU 10 determines whether the arrow traffic light direction covers all directions included in the road marking direction. When the driving assist ECU 10 determines that the arrow traffic light direction covers all directions included in the road marking direction, the driving assist ECU 10 determines that the own vehicle is permitted to move (S18: Yes).

On the other hand, when the driving assist ECU 10 determines that the own vehicle is not permitted to move by the traffic light (S18: No), the driving assist ECU 10 terminates executing this informing control routine.

When the driving assist ECU 10 determines that the own vehicle is permitted to move by the traffic light (S18: Yes), the driving assist ECU 10 proceeds with the process to a step S19 to start to activate a timer to measure an elapsing amount of time T. The elapsing amount of time T represents an amount of time elapsing after the own vehicle is permitted to move or start to move in response to the traffic light changing.

Next, the driving assist ECU 10 proceeds with the process to a step S20 to determine whether the own vehicle is still stopped. When the driving assist ECU 10 determines that the own vehicle is still stopped, the driving assist ECU 10 proceeds with the process to a step S21 to determine whether the elapsing amount of time T reaches a predetermine time Tref. When the driving assist ECU 10 determines that the elapsing amount of time T does not reach the predetermine time Tref, the driving assist ECU 10 returns the process to the step S20.

When the driving assist ECU 10 determines that the own vehicle starts to move before the elapsing amount of time T reaches the predetermined time Tref (S20: No), the driving assist ECU 10 terminates executing this informing control routine.

On the other hand, when the driving assist ECU 10 determines that the own vehicle is still stopped when the elapsing amount of time T reaches the predetermined time Tref (S21: Yes), the driving assist ECU 10 proceeds with the process to a step S22 to determine whether the preceding vehicle is stopped ahead of the own vehicle. When the driving assist ECU 10 determines that the preceding vehicle is stopped ahead of the own vehicle (S22: Yes), the driving assist ECU 10 terminates executing this informing control routine.

When the driving assist ECU 10 determines that the preceding vehicle is not stopped ahead of the own vehicle (S22: No), the driving assist ECU 10 proceeds with the process to a step S23 to inform the driver that the lighting state of the traffic light changes, and the own vehicle can start to move, to prompt the driver to start to move the own vehicle. In this case, the driving assist ECU 10 causes the speakers 70 to generate the buzzer sound for a predetermined amount of time and sends the traffic light change informing request command to the meter ECU 60. The meter ECU 60 displays the traffic light change messages on the meter display 61 and the HUD 62 in response to receiving the traffic light change informing request command sent from the driving assist ECU 10.

Thereby, the driver may notice that the traffic light changes and start to move the own vehicle.

When the driving assist ECU 10 detects that the own vehicle starts to move, the driving assist ECU 10 sends a traffic light change informing termination command to the meter ECU 60. Thereby, the traffic light change messages displayed on the meter display 61 and the HUD 62 are cleared. In this embodiment, there is an upper limit of an amount of time to display the traffic light change messages. Thus, the driving assist ECU 10 measures an elapsing amount of time elapsing since the driving assist ECU 10 sends the traffic light change informing request command to the meter ECU 60. When the driving assist ECU 10 determines that (i) the elapsing amount of time reaches an upper limit display amount of time, and (ii) the driving assist ECU 10 has not detected that the own vehicle starts to move, the driving assist ECU 10 sends the traffic light change informing termination command to the meter ECU 60.

After the driving assist ECU 10 executes a process of the step S23, the driving assist ECU 10 terminates executing this informing control routine. When a predetermined calculation interval elapses since the driving assist ECU 10 terminates executing the informing control routine, the driving assist ECU 10 starts to execute the informing control routine.

In this embodiment, the driver of the own vehicle can set the predetermined amount of time Tref by operating a setting operator (not shown). For example, the driver can select an amount of time as the predetermined amount of time Tref from several amounts of time, for example, two seconds, four seconds, six seconds, etc. by operating the setting operator.

<Memorized Data Keeping Determination Routine>

Next, the memorized information keeping determination process of the step S14 will be described. FIG. 5 shows the memorized information keeping determination routine to realize the memorized information keeping determination process. When the driving assist ECU 10 starts to execute the memorized information keeping determination routine, the driving assist ECU 10 proceeds with the process to a step S141 to determine whether at least one of the own vehicle determination conditions 1-1 and 1-2 is satisfied. Determining whether at least one of the own vehicle determination conditions 1-1 and 1-2 is satisfied, corresponds to determining whether a lane change moving of the own vehicle is detected. The lane change moving of the own vehicle is a moving of the own vehicle to change the lane.

After the own vehicle changes the lanes, the lane in which the own vehicle is now moving, is different from the lane in which the own vehicle was previously moving. Thus, the road marking direction memorized in the memory 12a may be wrong. Accordingly, when the lane change moving of the own vehicle is detected (S141: Yes), the driving assist ECU 10 proceeds with the process to a step S142 to determine not to keep the memorized road marking information (i.e., the memorized road marking direction).

When the driving assist ECU 10 determines that the own vehicle determination conditions 1-1 and 1-2 are not satisfied (S141: No), the driving assist ECU 10 proceeds with the process to a step S143. When the driving assist ECU 10 proceeds with the process to the step S143, the driving assist ECU 10 determines whether at least one of the preceding vehicle determination conditions 2-1 and 2-2 is satisfied. Determining whether at least one of the preceding vehicle determination conditions 2-1 and 2-2 is satisfied, corresponds to determining whether the moving direction of the preceding vehicle is different from the road marking direction. The road marking direction may include plural directions. When the moving direction of the preceding vehicle is covered by the road marking direction, the road marking direction memorized in the memory 12a is presumably correct. However, when the moving direction of the preceding vehicle is not covered by the road marking direction, the road marking direction memorized in the memory 12a is not presumably correct.

For example, when the left blinker of the preceding vehicle blinks, the moving direction of the preceding vehicle is a left turn direction. Therefore, when the left turn direction is covered by the road marking direction, the road marking direction is determined to correspond to the moving direction of the preceding vehicle. For example, when (i) a left turn moving of the preceding vehicle is detected, based on the moving route of the preceding vehicle, and (ii) the left turn direction is covered by the road marking direction, the road marking direction is determined to correspond to the moving direction of the preceding vehicle.

When the driving assist ECU 10 determines that the moving direction of the preceding vehicle is different from the road marking direction (S143: Yes), the driving assist ECU 10 proceeds with the process to a step S142 to determine not to keep the memorized road marking information. On the other hand, when the driving assist ECU 10 determines that the moving direction of the preceding vehicle corresponds to the road marking direction, the driving assist ECU 10 proceeds with the process to a step S144.

When the driving assist ECU 10 proceeds with the process to the step S144, the driving assist ECU 10 determines whether the moving distance determination condition 3 is satisfied. The arrow road markings are provided with a constant distance interval. Therefore, when one arrow road marking is detected, and another arrow road marking is not detected before the own vehicle moves for a constant distance after the one arrow road marking is detected, the road marking direction memorized in the memory 12a may be an outdated information which should not be used in the traffic light change informing control.

Accordingly, when the driving assist ECU 10 determines that the moving distance determination condition 3 is satisfied (S144: Yes), i.e., when the driving assist ECU 10 determines that the moving distance d of the own vehicle after the arrow road marking is previously detected, reaches the predetermined distance dref, the driving assist ECU 10 proceeds with the process to a step S142 to determine not to keep the memorized road marking information. On the other hand, when the driving assist ECU 10 determines that the moving distance d of the own vehicle does not reach the predetermined distance dref (S144: Yes), the driving assist ECU 10 proceeds with the process to a step S142 to determine to keep the memorized data on the road marking information.

After the driving assist ECU 10 executes a process of the step S142 or the step S145, the driving assist ECU 10 proceeds with the process to the step S15 of the traffic light change informing control routine from the memorized information keeping determination routine. When the driving assist ECU 10 determines to keep the memorized data on the road marking direction, the driving assist ECU 10 proceeds with the process to the step S16. On the other hand, when the driving assist ECU 10 determines not to keep the memorized data on the road marking direction, the driving assist ECU 10 proceeds with the process to the step S17.

According to the vehicle driving assist apparatus 1 described above, the driver is prompted to start to move the own vehicle when the own vehicle is determined to be permitted to move in the road marking direction by the traffic light, based on the road marking direction and the arrow traffic light direction. Thereby, the own vehicle is properly prompted to start to move at the intersection with the arrow traffic light.

Moreover, when the lane change moving of the own vehicle is detected, the data on the road marking information memorized in the memory 12a, is deleted. Therefore, a wrong informing to the driver of the own vehicle can be prevented. In other word, the wrong informing to prompt the driver to start to move the own vehicle, can be prevented.

Moreover, a performance of the driving assist ECU 10 to recognize the road marking direction may be limited. For example, when paint of the road marking is damaged, the driving assist ECU 10 may erroneously recognize the road marking direction. According to the vehicle driving assist apparatus 1 according to the embodiment of the invention, when the moving direction of the preceding vehicle indicated by the blinkers or the direction of the moving route of the preceding vehicle is different from the road marking direction memorized in the memory 12a even when the wrong road marking direction is recognized and memorized in the memory 12a. Thereby, the wrong informing to the driver of the own vehicle can be prevented.

Moreover, when the arrow road marking is detected and thereafter, the own vehicle has moved the predetermined distance, the data on the road marking information memorized in the memory 12a is deleted. Therefore, the wrong informing to the driver of the own vehicle can be prevented.

Moreover, when there is the stopped preceding vehicle ahead of the own vehicle, the informing to prompt the driver of the own vehicle to start to move the own vehicle, is not performed. Thereby, an unnecessary informing to the driver can be prevented.

The vehicle driving assist apparatus according to the embodiment of the invention has been described. The invention is not limited to the embodiment and can be variously modified without departing from the object of the invention.

For example, the memorized data deletion condition used in the step S14 can be optionally set. For example, the memorized data deletion condition may include only the own vehicle determination condition, or only the preceding vehicle condition, or only the moving distance determination condition. Alternatively, the memorized data deletion condition may include an optional combination of two or more of the own vehicle determination condition, the preceding vehicle condition, and the moving distance determination condition. Further, the own vehicle determination condition is not limited to the own vehicle determination conditions 1-1 and 1-2. For example, the own vehicle determination condition may be one of the own vehicle determination conditions 1-1 and 1-2. Furthermore, the preceding vehicle determination condition is not limited to the preceding vehicle determination conditions 2-1 and 2-2. For example, the preceding vehicle determination condition may be one of the preceding vehicle determination conditions 2-1 and 2-2.

Moreover, the memorized data deletion condition may include a condition that the blinkers of the own vehicle indicating the moving direction different from the road marking direction memorized in the memory 12a, blinks when the own vehicle is stopped.

Moreover, according to the vehicle driving assist apparatus 1, the messages are displayed on the meter display 61 and the HUD 62. In this regard, the messages may be displayed on any one of the meter display 61 and the HUD 62. Further, a method of the informing is not limited to displaying the messages. The informing may be realized by voice announcement. Furthermore, in place of generating the buzzer sounds, a steering wheel or a driver's seat may be vibrated.

Moreover, according to the vehicle driving assist apparatus 1, the driving assist ECU 10 acquires the traffic light information (including the arrow traffic light information) of the traffic light TL by analyzing the images taken by the camera 20 to recognize the lighting states of the traffic light TL (including the lighting states of the arrow traffic light). In this regard, the driving assist ECU 10 may be configured to acquire the traffic light information (including the arrow traffic light information) of the traffic light TL transmitted from equipment (not shown) provided at the side of the road to recognize the lighting states of the traffic light TL (including the lighting states of the arrow traffic light).

What is claimed is:

1. A vehicle driving assist apparatus, comprising an electronic control unit configured to prompt a driver of an own vehicle to start to move the own vehicle when the own vehicle is still stopped after an oncoming traffic light ahead of the own vehicle permits the own vehicle to start to move,
wherein:
the vehicle driving assist apparatus further comprises at least one senso which detects an arrow road marking on a road in a lane in which the own vehicle is moving; and
the electronic control unit is configured to:
(i) acquire road marking information on the road arrow marking detected by the at least one sensor, (ii) recognize a moving direction of the own vehicle permitted by the detected arrow road marking, based on the acquired road marking information, and (iii) memorize the recognized moving direction as a road marking direction;
(i) acquire a lighting state of an oncoming arrow traffic light ahead of the own vehicle and (ii) recognize a moving direction of the own vehicle permitted by the oncoming arrow traffic light as an arrow traffic light direction, based on the acquired lighting state;
determine whether the oncoming arrow traffic light permits the own vehicle to move in the memorized arrow traffic light direction, based on (i) the memorized road marking direction and (ii) the recognized arrow traffic light direction; and
prompt the driver of the own vehicle to start to move the own vehicle when the own vehicle is still stopped after the electronic control unit determines that the oncoming arrow traffic light permits the own vehicle to move in the memorized arrow traffic light direction.

2. The vehicle driving assist apparatus as set forth in claim 1, wherein:
the electronic control unit is configured to delete the memorized road marking direction when the electronic control unit determines that the own vehicle changes lanes.

3. The vehicle driving assist apparatus as set forth in claim 1, wherein:
the electronic control unit is configured to delete the memorized road marking direction when the electronic control unit determines that (i) a blinker of a preceding vehicle ahead of the own vehicle blinks, and (ii) a moving direction of the preceding vehicle indicated by the blinking blinker is different from the memorized road marking direction.

4. The vehicle driving assist apparatus as set forth in claim 1, wherein:
the electronic control unit is configured to delete the memorized road marking direction when the electronic control unit determines that a moving direction of a preceding vehicle ahead of the own vehicle is different from the memorized road marking direction.

5. The vehicle driving assist apparatus as set forth in claim 1, wherein:
the electronic control unit is configured to delete the memorized road marking direction when the electronic control unit determines that a moving distance of the own vehicle since the arrow road marking is lastly detected, reaches a predetermined distance.

6. The vehicle driving assist apparatus as set forth in claim 1, wherein:
the electronic control unit is configured to (i) acquire the lighting state of the oncoming arrow traffic light and (ii) recognize the moving direction of the own vehicle permitted by the oncoming arrow traffic light as the arrow traffic light direction, based on the acquired lighting state when the own vehicle is stopped.

7. The vehicle driving assist apparatus as set forth in claim 1, wherein:
the electronic control unit is configured to prompt the driver of the own vehicle to start to move the own vehicle when the own vehicle is still stopped when a predetermined amount of time elapses since the electronic control unit determines that the oncoming arrow traffic light permits the own vehicle to move in the memorized arrow traffic light direction.

8. The vehicle driving assist apparatus as set forth in claim 1, wherein:
the electronic control unit is configured to delete the memorized road marking direction when the electronic control unit determines that (i) a blinker of the own vehicle blinks, and (ii) a moving direction indicated by the blinking blinker of the own vehicle is different from the memorized road marking direction.

9. The vehicle driving assist apparatus as set forth in claim 1, wherein:
the at least one sensor includes a camera which takes images of a view ahead of the own vehicle; and
the electronic control unit is configured to acquire the road marking information from information on the images taken by the camera.

10. The vehicle driving assist apparatus as set forth in claim 9, wherein:
the electronic control unit is configured to acquire the lighting state of the oncoming arrow traffic light from the information on the images taken by the camera.
